(19) United States
(12) Patent Application Publication
(10) Pub. No.: US 2016/0057429 A1
(43) Pub. Date: Feb. 25, 2016

(54) CODING APPARATUS, METHOD, COMPUTER PRODUCT, AND COMPUTER SYSTEM

(71) Applicant: FUJITSU LIMITED, Kawasaki-shi (JP)

(72) Inventor: Fang YIN, Kawasaki (JP)

(21) Appl. No.: 14/767,546

(22) Filed: Aug. 12, 2015

Related U.S. Application Data
(63) Continuation of application No. PCT/JP2013/058864, filed on Mar. 26, 2013.

(51) Int. Cl. H04N 19/139; H04N 19/172; H04N 19/176; H04N 19/513

(52) U.S. Cl. CPC H04N 19/139; H04N 19/521; H04N 19/172; H04N 19/176

(57) ABSTRACT

A coding apparatus includes a specifying circuitry configured to specify concerning a reference frame that is a reference for a given frame that is to be coded and is in a series of frames, a block size when a motion vector of a block divided from the reference frame is detected, the block size being specified from among plural block size candidates of the block; and a selecting circuitry configured to select from among the plural block size candidates, a block size candidate to divide the given frame, when a motion vector of a block divided from the given frame is detected. The block size candidate is selected based on the block size specified by the specifying circuitry.

### CROSS REFERENCE TO RELATED APPLICATIONS

This application is a continuation application of International Application PCT/JP2013/058864, filed on Mar. 26, 2013 and designating the U.S., the entire contents of which are incorporated herein by reference.

### FIELD

The embodiments discussed herein are related to a coding apparatus, method, computer product, and computer system.

### BACKGROUND

Conventionally, a block that is similar to a given block into which a given frame that is to be coded in video has been divided is searched for from a reference frame; and a difference in spatial positioning from the given block to the similar block is detected as a motion vector of the given block. Further, there is another technique in which the block size of a given block is variable and a motion vector is detected to suppress drops in video quality after coding.

According to a related technique, for example, a compressed reference image and an image to be compressed and coded are generated; and based on the reliability and magnitude of area motion vectors of compressed partial area images dividing into plural areas, the image to be compressed and coded, size candidates for a block to be coded are narrowed down. Further, according to another known technique, concerning plural block sizes selected based on an evaluation value generated from difference information of a video signal and a signal subject to filter processing by an input signal of a motion compensated prediction scheme, a new evaluation value is calculated from the difference information and based on the new evaluation value, an optimal block size is selected. (For example, refer to Japanese Laid-Open Patent Publication Nos. 2006-180196 and 2007-060164.

Nonetheless, with the conventional techniques, the volume of computation involved in motion vector detection increases when the block size is variable and a motion vector candidate is obtained for each block size candidate.

### SUMMARY

According to an aspect of an embodiment, a coding apparatus includes a specifying circuitry configured to specify concerning a reference frame that is a reference for a given frame that is to be coded and is in a series of frames, a block size when a motion vector of a block divided from the reference frame is detected, the block size being specified from among plural block size candidates of the block; and a selecting circuitry configured to select from among the plural block size candidates, a block size candidate to divide the given frame, when a motion vector of a block divided from the given frame is detected. The block size candidate is selected based on the block size specified by the specifying circuitry.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an operation example of a coding apparatus according to an embodiment;

FIG. 2 is a block diagram depicting an example of hardware of a computer system;

FIG. 3 is a block diagram depicting an example of a hardware configuration of the coding apparatus;

FIG. 4 is a diagram depicting an example of the relation between a CTB and a CU;

FIG. 5 is a diagram depicting an example of CU types;

FIG. 6 is a diagram depicting an example of PU types;

FIG. 7 is a block diagram depicting a functional example of the coding apparatus;

FIGS. 8A and 8B are diagrams depicting examples of reference frame depth;

FIG. 9 is a diagram depicting a first example of depth candidates for performing motion vector detection for a given frame;

FIG. 10 is a diagram depicting a second example of depth candidates for performing motion vector detection for a given frame;

FIG. 11 is a diagram depicting a third example of depth candidates for performing motion vector detection for a given frame;

FIG. 12 is a flowchart depicting a first example of a procedure of a motion vector detection process in a given frame;

FIG. 13 is a flowchart of a second example of the procedure of the motion vector detection process in a given frame;

FIG. 14 is a flowchart depicting an example of a procedure of a first motion vector detection process; and

FIG. 15 is a flowchart depicting an example of a procedure a second motion vector detection process.

### DESCRIPTION OF EMBODIMENTS

Embodiments of a coding apparatus, method, program, computer system, and recording medium will be described in detail with reference to the accompanying drawings.

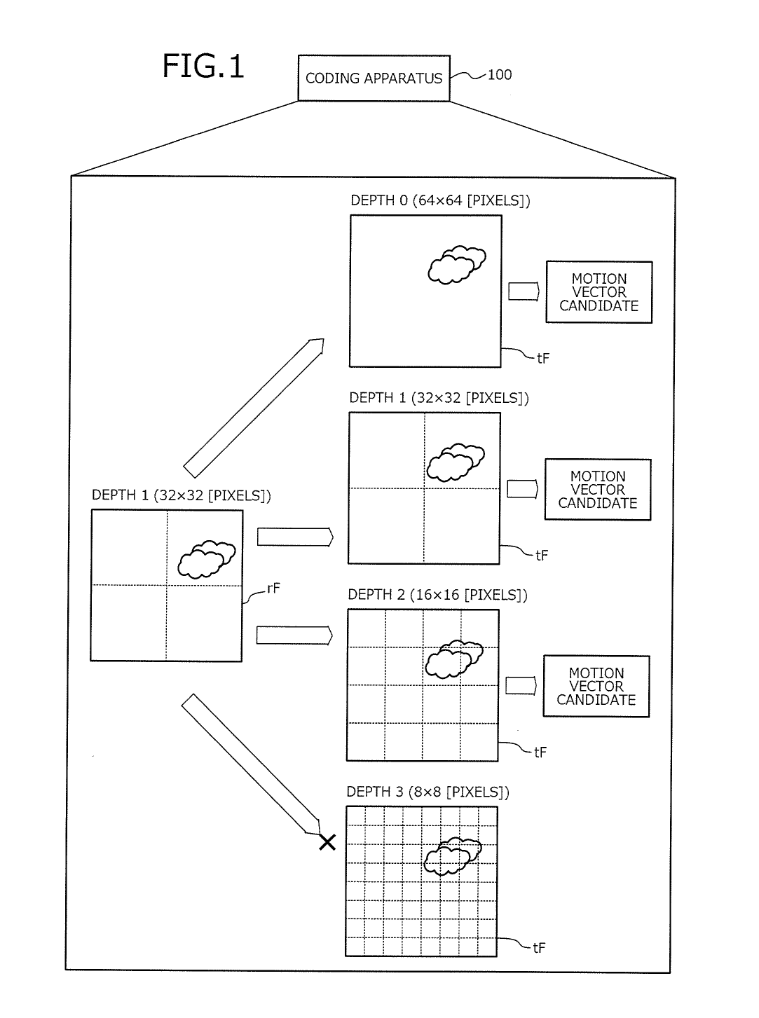

FIG. 1 is a diagram depicting an operation example of the coding apparatus according to an embodiment. A coding apparatus 100 is a computer that detects motion vectors. The coding apparatus 100 codes according to the standard prescribed by High Efficiency Video Coding (HEVC), video for each block into which a frame has been divided.

Standards prior to HEVC such as H.264 and Moving Picture Experts Group (MPEG)-2 divided each frame of video by 16×16 [pixel] blocks and performed a coding process on each block. In contrast, HEVC provides a scheme that has a higher degree of freedom in the size of the block into which video is divided.

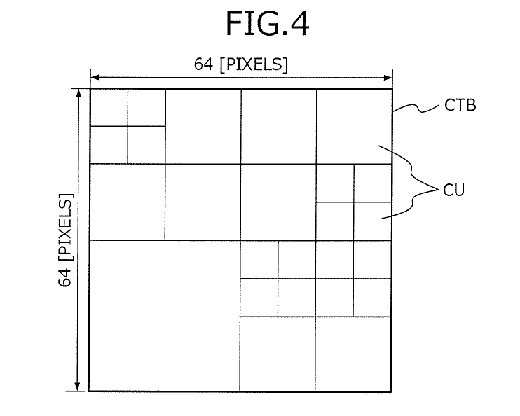

More specifically, under HEVC, a frame is divided into square blocks of N×N [pixels], where N is an integer. An N×N [pixel] square block is referred to as the largest coding unit (LCU). Under HEVC, N is 64 and the LCU is divided into coding tree blocks (CTBs). A CTB is divided into blocks called coding units (CUs). The relation between a CTB and a CU will be described with reference to FIG. 4. There are 4 types of block size candidates for a CU, including 64×64 [pixels], 32×32 [pixels], 16×16 [pixels], and 8×8 [pixels].

A 64×64 [pixel] CU is defined as depth 0. A 32×32 [pixel] CU is defined as depth 1. A 16×16 [pixel] CU is defined as depth 2. An 8×8 [pixel] CU is defined as depth 3.

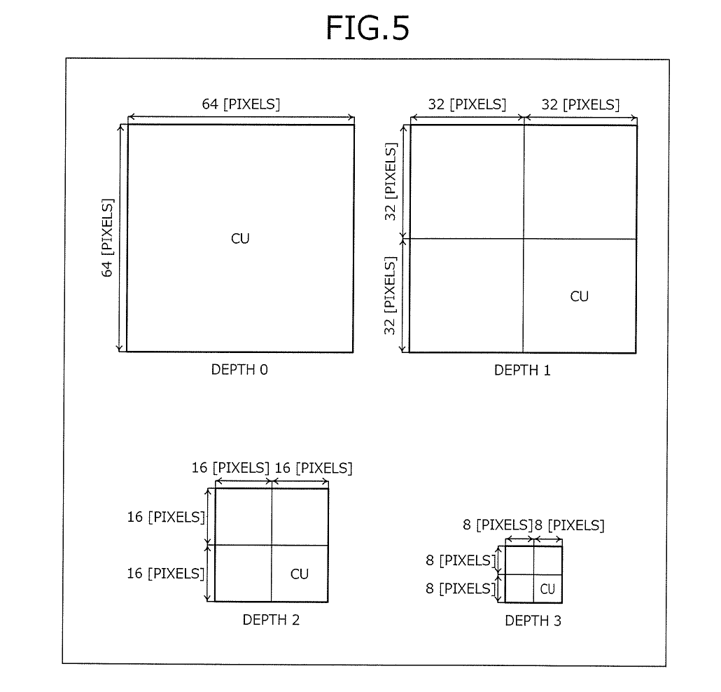

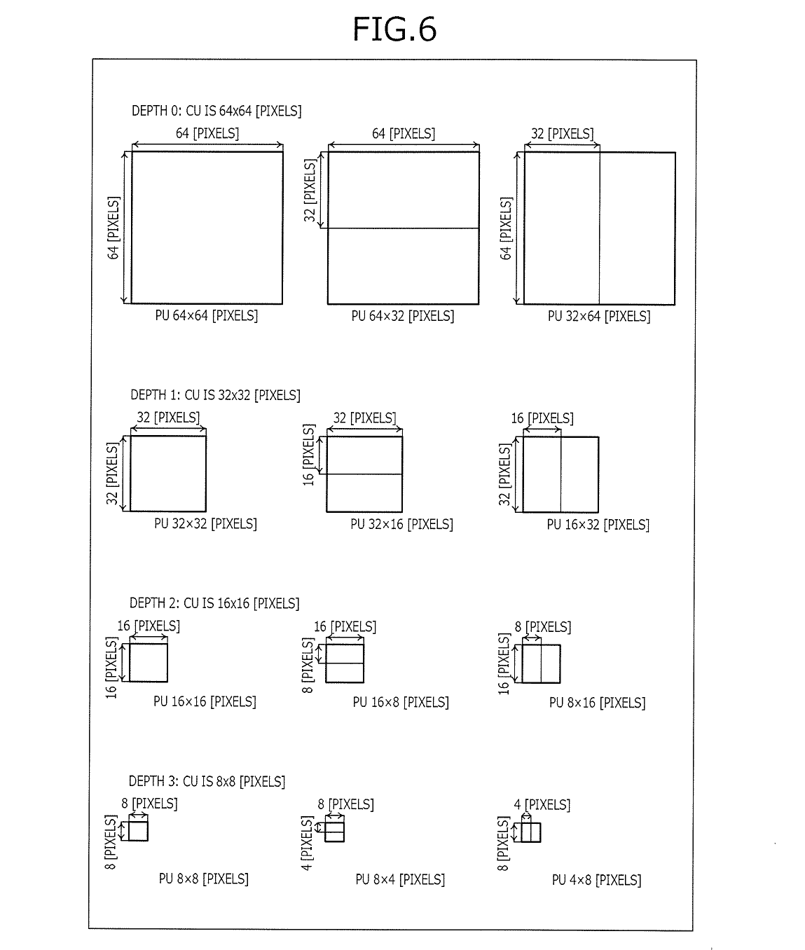

Hereinafter, the size of a CU will be referred to as “depth”. Further, a block size candidate for a CU will be referred to as simply “depth candidate” hereinafter. Depth will be described with reference to FIG. 5. Further, under HEVC, a CU is further divided into prediction units (PUs), units by which interframe prediction is performed. Types of PUs will be described with reference to FIG. 6.

In a motion vector detection process of a compression coding scheme, in a given frame subject to coding, position coordinates of an object are evaluated with respect to a reference frame of a block and position coordinates of the most similar block are detected. A motion vector represents position coordinates of a block to the position coordinates of the most similar block.

An apparatus that codes according the standard prescribed by HEVC performs a process of determining for each depth candidate among plural depth candidates, motion vector candidates for a CU. Further, the apparatus detects, as a motion vector, the motion vector candidate that is most similar among the motion vector candidates detected for each depth candidate for the CU. More specifically, a motion vector is determined for each PU into which the CU is divided, however, in FIG. 1, description is simplified as “detect motion vectors for CU”.

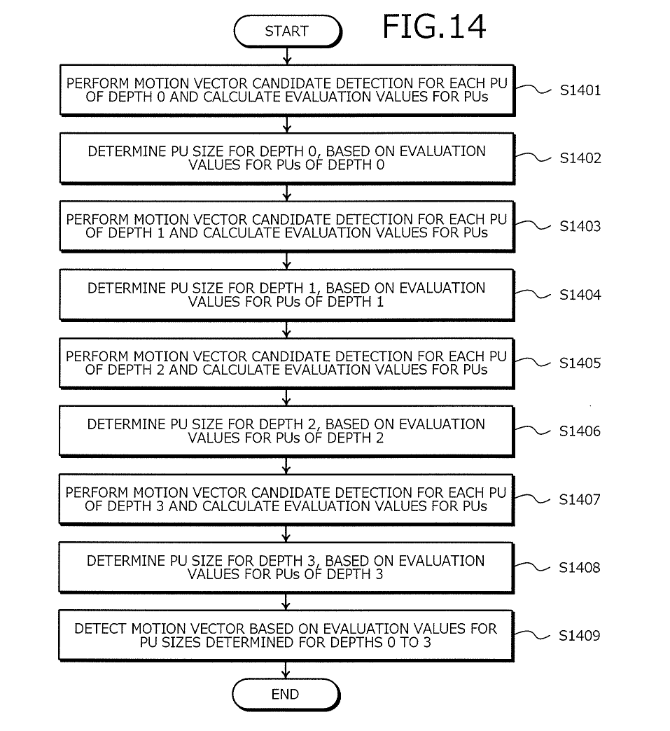

More specifically, an apparatus that performs coding calculates an evaluation value that represents a difference of the pixel value of a block obtained by dividing according to the respective depth candidates and the pixel value of a reference block within a search range on the reference frame and indicated by a motion vector candidate. Further, for each block of the respective depth candidates, the apparatus that performs coding regards the motion vector for which the evaluation value is smallest to be a motion vector candidate. Subsequently, the apparatus that performs coding detects as the motion vector, the motion vector candidate for which the evaluation value is smallest among the motion vector candidates for the blocks of the respective depth candidates. A detailed example of the evaluation value will be described with reference to FIG. 14.

As a result, an apparatus that codes according to the standard prescribed by HEVC is able to code a portion near an edge portion in a CTB by a CU size that is a small unit while coding a portion for which change is minimal by a CU size that is a large unit. Nonetheless, since motion vector candidates are obtained for each CU size when coding is performed according to the standard prescribed by HEVC, the volume of computation involved in the motion vector detection process is large.

Thus, when performing motion vector detection for a block of a given frame, the coding apparatus 100 according to the present embodiment uses a block size that is approximately the block size employed at the time of motion vector detection for a block of the reference frame. As a result, the coding apparatus 100 can suppress drops in video quality after coding and can reduce the volume of computation involved in the motion vector detection process.

FIG. 1 depicts a given frame tF that is to be coded among a series of frames, and a reference frame rF that is a reference for the given frame tF. The series of frames is assumed to be video of an object that does not change much, such as the sky. The reference frame rF is a frame that has already been coded. The given frame tF depicted in FIG. 1 depicts a state where clouds shot in the reference frame rF depicted in FIG. 1 have moved toward the left. Thus, the reference frame rF and the given frame tF have a high possibility of being similar images.

The coding apparatus 100 is assumed to regard a motion vector candidate of a block of 32×32 [pixels], which is depth 1 among the 4 types of depth candidates, to be the most similar to a CTB of the reference frame rF.

The coding apparatus 100 specifies from among the depth candidates divided from the reference frame rF, the depth when the motion vector of the CU is detected. In the example depicted in FIG. 1, the coding apparatus 100 specifies the depth as the size of the CU.

When detecting the motion vector of a CU divided from the given frame tF, the coding apparatus 100 selects from among the plural depth candidates and based on the specified size of the CU, any depth candidate to divide the given frame tF. The any depth candidate may be singular or plural.

In the example depicted in FIG. 1, among the plural depth candidates, the coding apparatus 100 selects as the any depth candidate, depth 0 to depth 2, which are approximately depth 1. After selecting depth candidates, the coding apparatus 100, determines for each any depth candidate, a motion vector candidate for each CU divided by the selected CU size.

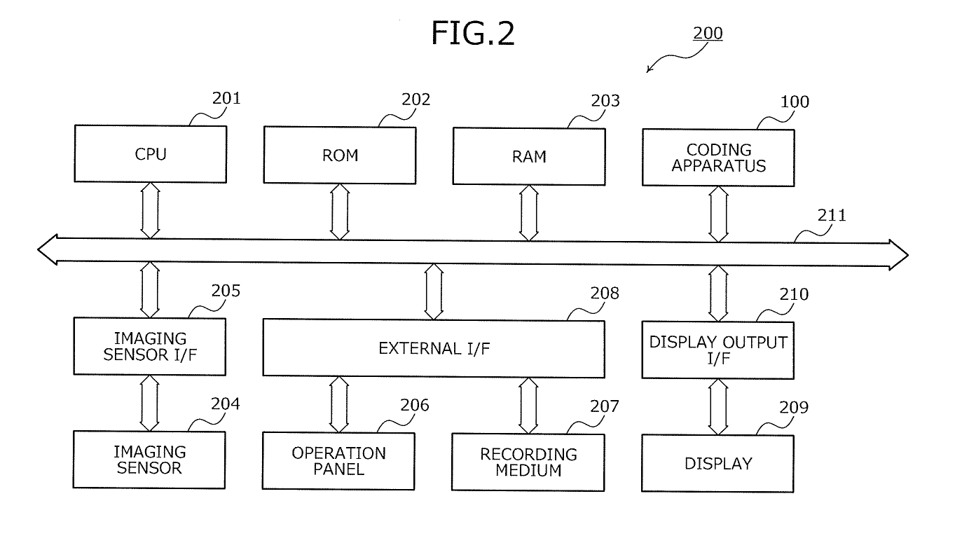

Thus, the coding apparatus 100 narrows down the motion vector candidates of the selected any depth candidates to obtain a motion vector candidate and thereby, suppresses drops in image quality and enables reduction of the volume of computation involved in motion vector detection. Here, a process of determining motion vector candidates for plural depth candidates and detecting a motion vector is regarded as a first motion vector detection process. Further, a process of determining motion vector candidates for a selected any depth candidate among the plural depth candidates and detecting a motion vector is regarded as a second motion vector detection process. Hereinafter, the coding apparatus 100 will be described with reference to FIGS. 2 to 15.

An example of hardware of a computer system 200 to which the coding apparatus 100 is applied will be described. The computer system 200, for example, is a system having a function of recording and playing video and more specifically, for example, is a personal computer, a television, a recorder, a smartphone, a video camera, a digital camera, and the like.

FIG. 2 is a block diagram depicting an example of hardware of the computer system. In FIG. 2, the computer system 200 includes a central processing unit (CPU) 201, read-only memory (ROM) 202, and random access memory (RAM) 203. The computer system 200 further includes an imaging sensor 204, an imaging sensor interface (I/F) 205, an operation panel 206, a recording medium 207, an external I/F 208, and the coding apparatus 100.

The computer system 200 further includes a display 209 and a display output I/F 210. The CPU 201 to the RAM 203, the imaging sensor I/F 205, the external I/F 208, the display output I/F 210, and the coding apparatus 100 are mutually connected by a bus 211.

The CPU 201 is computation processing apparatus that governs overall control of the computer system 200. The ROM 202 is non-volatile memory storing therein programs such as a boot program of the computer system 200. The RAM 203 is volatile memory used as a work area of the CPU 201.

The imaging sensor 204 is an apparatus that converts light from a physical object into an electronic signal. For example, the imaging sensor 204 is a charge coupled device (CCD), a complementary metal oxide semiconductor (CMOS), etc.

The imaging sensor I/F 205 is an apparatus that controls the imaging sensor 204 during recording and thereby, converts a signal from the imaging sensor 204 into an image format and stores the result to the RAM 203. The operation panel 206 is a liquid crystal touch panel, operation button, etc. of the computer system 200. The recording medium 207 is a storage apparatus such as flash ROM. Further, the recording medium 207 may store the coding program according to the present embodiment. The external I/F 208 controls the operation panel 206 and the recording medium 207. Further, the external I/F 208 may be connected to a network such as a local area network (LAN), a wide area network (WAN), and the Internet via a communications line, and to an apparatus other than the computer system 200 through the network.

The display 209 displays the image format recorded by the imaging sensor 204. The display output I/F 210 controls the display 209.

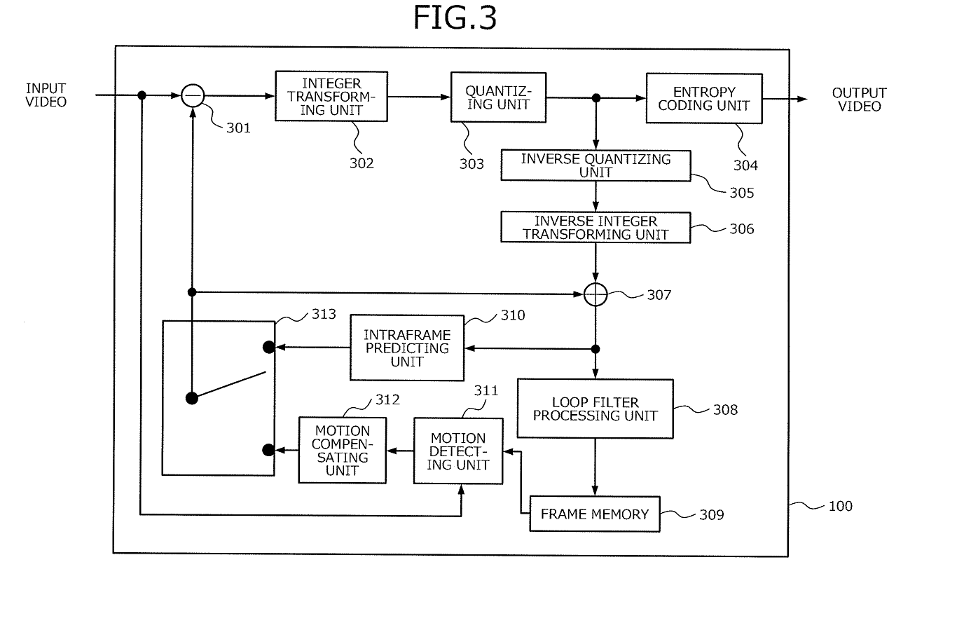

FIG. 3 is a block diagram depicting an example of a hardware configuration of the coding apparatus. The coding apparatus 100 has a prediction error signal generating unit 301, an integer transforming unit 302, a quantizing unit 303, an entropy coding unit 304, an inverse quantizing unit 305, an inverse integer transforming unit 306, a reference frame generating unit 307, and a loop filter processing unit 308. The coding apparatus 100 further has frame memory 309, an intraframe predicting unit 310, a motion detecting unit 311, a motion compensating unit 312, and a predicted image selecting unit 313.

Input video is assumed to be video for which quadtree block division has been employed for division into the frames forming the video. The prediction error signal generating unit 301 receives input of a predicted image signal and a given frame tF in the input video and generates a prediction error signal by computing the difference of the given frame tF and a reference frame rF, which is the predicted frame.

The integer transforming unit 302 outputs a signal obtained by performing integer transform on the prediction error signal from the prediction error signal generating unit 301. The quantizing unit 303 quantizes the signal output from the integer transforming unit 302. The coding volume of the prediction error signal is reduced consequent to the processing by the quantizing unit 303.

The entropy coding unit 304 performs entropy coding on the quantized data from the quantizing unit 303, the output data from the intraframe predicting unit 310, and information concerning the motion vector output from the motion detecting unit 311; and outputs coded image data for the given frame tF. Image data coded for the frames of the input video and output is output video. Here, entropy coding points to a coding scheme of assigning code of a length variable according symbol appearance frequency.

The inverse quantizing unit 305 performs inverse quantization on the quantized data from the quantizing unit 303. The inverse integer transforming unit 306 performs inverse integer transform processing on the output data from the inverse quantizing unit 305. A signal comparable to the prediction error signal before coding can be obtained consequent to the processing by the inverse integer transforming unit 306.

The reference frame generating unit 307 adds the pixel value of the PU compensated for motion by the motion compensating unit 312 and the prediction error signal decoded by the inverse quantizing unit 305 and the inverse integer transforming unit 306. A pixel value of a PU of the motion compensated reference frame rF is generated consequent to the processing by the reference frame generating unit 307.

The loop filter processing unit 308 performs deblocking filter, sample adaptive offset (SAO), and adaptive loop filter (ALF) processing on the PU pixel value and after suppressing the occurrence of block noise, cumulates PU pixel values in the frame memory 309.

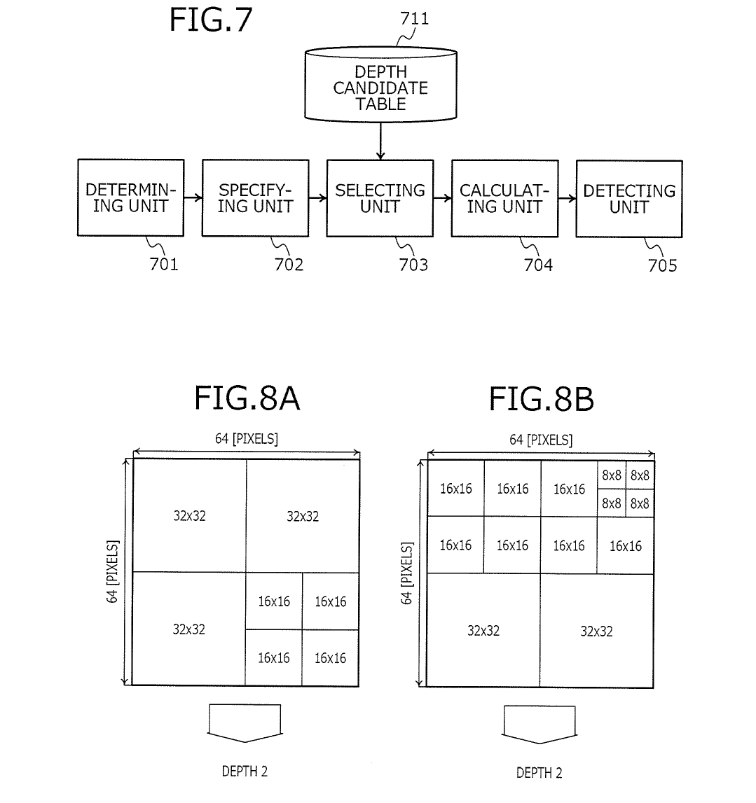

The intraframe predicting unit 310 generates from a nearby pixel in the same frame, a macroblock of the predicted image. The motion detecting unit 311 calculates a motion vector based on reference frame rF data read from the frame memory 309 and the pixel values of the input video and outputs the motion vector. Details of the motion detecting unit 311 will be described with reference to FIG. 7.

The motion compensating unit 312 generates a PU of a motion compensated predicted image by performing based on the motion vector motion output from the motion detecting unit 311, motion compensation on the reference frame rF data read from the frame memory 309.

The predicted image selecting unit 313 selects a macroblock of the predicted image output from the intraframe predicting unit 310 or a macroblock of the predicted image output from the motion compensating unit 312 and outputs the selected macroblock to the prediction error signal generating unit 301 and the reference frame generating unit 307. Here, the CTB, CU, and PU defined under HEVC will be described with reference to FIGS. 4 to 6.

FIG. 4 is a diagram depicting an example of the relation between a CTB and a CU. The LCU is divided into CTBs that are sub-blocks for performing transform and quantization. There are 3 types of CTBs, 16×16 [pixels], 32×32 [pixels], and 64×64 [pixels]. When a CTB is 16×16 [pixels], depths that the CU may take on are depth 2 and depth 3. When the CTB is 32×32 [pixels], the depths that the CU can take on are depths 1 to 3.

The CTB is recursively divided by quadtree block division, corresponding to characteristics of the image data. More specifically, a process is repeatedly performed where, the CTB is divided into 4 areas; a resulting area is further subdivided into 4 areas. An area resulting from this division is called a CU. A CU is a base unit of a coding process. In video to which quadtree block division has been employed, edge portions where change is substantial and portions near edge portions in an image can be coded by a small unit and portions for which change is minimal can be coded by a large unit. For example, an apparatus that performs coding by quadtree block division can use a small unit to encode portions outlining an object in a given image of video that is to be coded and can use a large unit to code portions having minimal change, such as the sky. Types of CUs will be described with reference to FIG. 5.

FIG. 5 is a diagram depicting an example of CU types. As depicted in FIG. 5, there are 4 types of CUs including 64×64 [pixels], which is depth 0; 32×32 [pixels], which is depth 1; 16×16 [pixels], which is depth 2; and 8×8 [pixels], which is depth 3. A CU is used to perform interframe prediction in units of PUs. Types of PUs will be described with reference to FIG. 6.

FIG. 6 is a diagram depicting an example of PU types. There are 3 types of PUs for each CU depth. A CU includes 1 or more PUs. A PU can be selected from among 3 types including a type that is the same size as the CU, a type divided horizontally into 2, and a type divided vertically into 2.

For example, when a CU is of depth 0, there are 3 types of PUs including 64×64 [pixels], 64×32 [pixels], and 32×64 [pixels]. As depicted in FIG. 6, there are 12 types of PUs, ranging from 8×8 [pixels] to 64×64 [pixels]. Further, the size of a PU is referred to as “PU size”.

Functions of the coding apparatus 100 will be described. FIG. 7 is a block diagram depicting a functional example of the coding apparatus. The coding apparatus 100 includes a determining unit 701, a specifying unit 702, a selecting unit 703, a calculating unit 704, and a detecting unit 705.

Functions of the determining unit 701 to the detecting unit 705 may be realized by executing on the CPU 201, a program stored in a storage apparatus. The storage apparatus, more specifically, for example, is the ROM 202, the RAM 203, the recording medium 207, etc. depicted in FIG. 2,

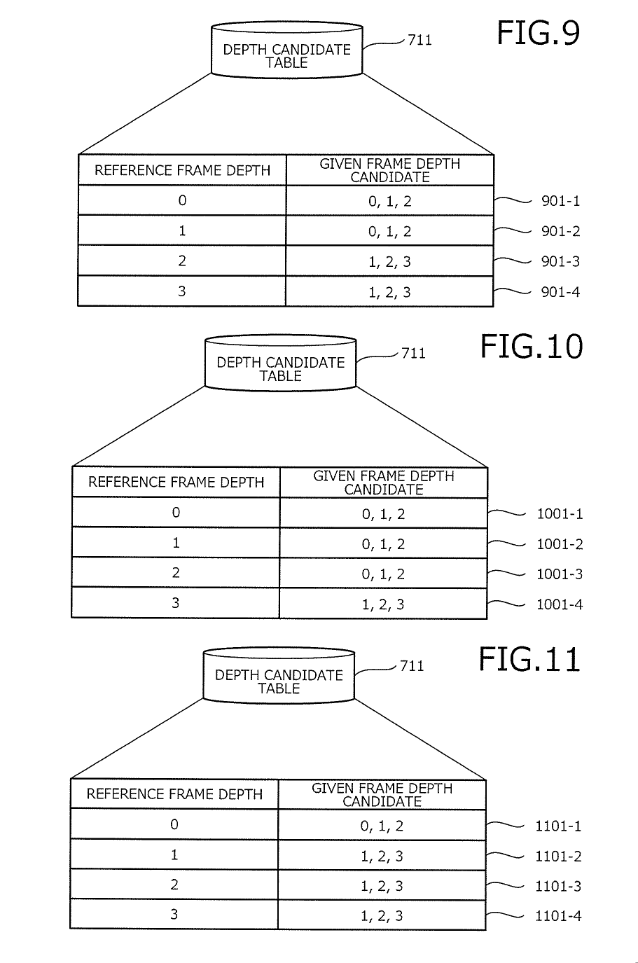

The coding apparatus 100 is able to access a depth candidate table 711. The depth candidate table 711 is stored in a storage area in the coding apparatus 100 or a storage apparatus such as the ROM 202, the RAM 203, and the recording medium 207. Examples of the contents of the depth candidate table 711 are depicted in FIGS. 9 to 11.

The determining unit 701 determines whether a given frame tF is a given i-th frame in a series of frames. Further, the determining unit 701 may determine whether a value representing the difference of the pixel value of the given frame tF and the pixel value of the reference frame rF is less than a given threshold. Here, the given i-th frame and given threshold are values specified by the developer or user of the coding apparatus 100.

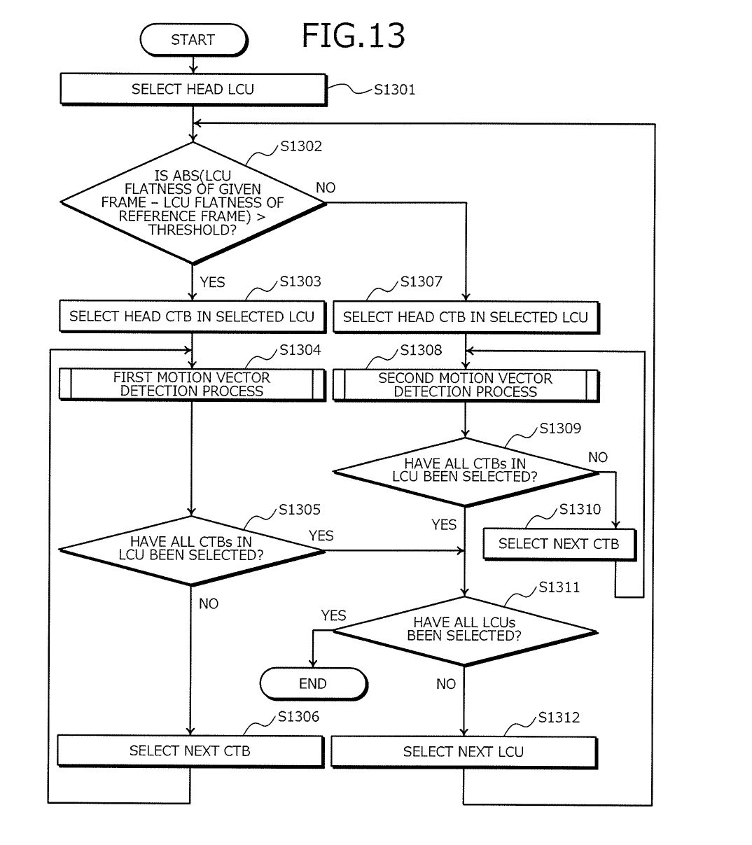

For example, the given i-th frame is the second to ninth frames, the eleventh to nineteenth frames, . . . . Further, the determining unit 701 may determine whether a given frame tF is not a given i-th frame in a series of frames. In this case, the given i-th frame is the first frame, the tenth frame, the twentieth frame, . . . . Further, for example, the determining unit 701 determines whether the difference of the average pixel value of the given frame tF and the average pixel value of the reference frame rF is less than a given threshold. Detailed description is given with reference to FIG. 13 hereinafter. Determination results are stored to a storage area in the coding apparatus 100.

From among plural depth candidates of a block divided from the reference frame rF, the specifying unit 702 specifies for the reference frame rF, the depth at the time when a motion vector of each PU in the CU is detected.

Further, the specifying unit 702 may specify the depth divided from the reference frame rF when the determining unit 701 determines that the given frame tF is the given i-th frame. For example, the specifying unit 702 may specify the depth divided from the reference frame rF, when the determining unit 701 determines that the frame is the second to ninth frame, the eleventh to nineteenth frame, . . . as the given i-th frame. The determining unit 701 may determine cases where the specifying unit 702 is not executed.

Further, the specifying unit 702 may specify the block size, when the determining unit 701 determines that the value is less than a given threshold. The specified depth is stored to a storage area in the coding apparatus 100.

From among the plural depth candidates, the selecting unit 703 selects any depth candidate to divide the given frame tF, based on the depth specified by the specifying unit 702 when motion vectors of PUs in a CU divided from the given frame tF are detected. A detailed selection procedure will be described with reference to FIGS. 9 to 11.

Further, plural depths may be specified by the specifying unit 702 when a motion vector of a block divided from the reference frame rF is detected. In this case, the selecting unit 703 may select from among the plural depth candidates, any depth candidate to divide the given frame tF, based on a depth that is relatively small among the plural depths. Further, in a case where plural depths are specified, the selecting unit 703 may select from among the plural depth candidates, any depth candidate to divide the given frame tF, based on a count of the CUs divided according to each of the depths. A case where plural depths are specified will be described with reference to FIGS. 8A and 8B. Further, the selected depth candidate is stored to a storage area in the coding apparatus 100.

The calculating unit 704 calculates corresponding to the any depth candidate selected by the selecting unit 703, an evaluation value that represents the difference between the pixel value of CUs divided from the given frame tF according to the any depth candidate and the pixel value of a block within a search range on the reference frame rF. A detailed example of evaluation value calculation will be described hereinafter with equation (2).

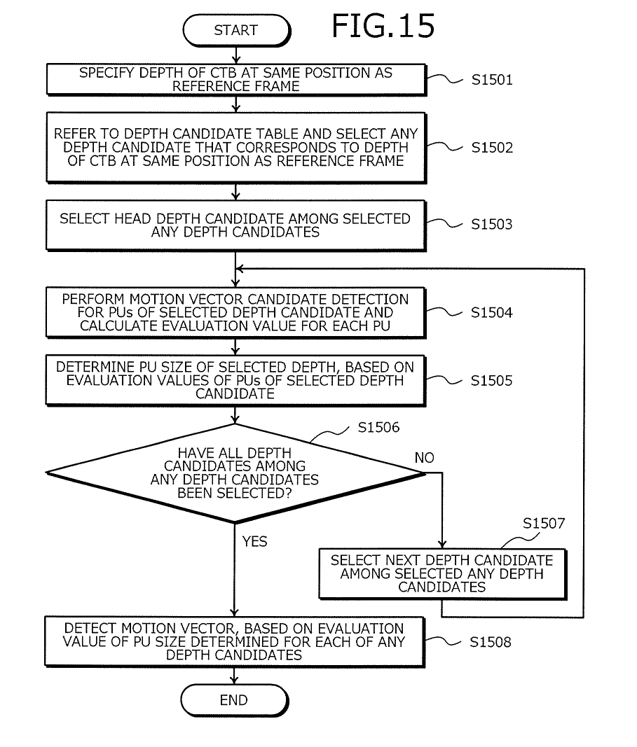

The detecting unit 705 detects based on the evaluation values calculated by the calculating unit 704 for blocks resulting from division according to the any block size candidate, the motion vector of a block into which the given frame tF has been divided. Detailed detection examples will be described will reference to FIGS. 14 and 15. The calculated motion vector is stored to a storage area in the coding apparatus 100.

FIGS. 8A and 8B are diagrams depicting examples of reference frame depth. The coding apparatus 100 specifies a depth result for a reference frame rF based on CUs included in a CTB of the reference frame rF. In this case, FIGS. 8A and 8B will be described in an instance where plural depth results for the reference frame rF are specified.

With reference to FIG. 8A, an example will be described where the coding apparatus 100 selects any depth candidate to divide a given frame tF, based on the CU having the smallest size among the CUs included in a CTB of the reference frame rF. With reference to FIG. 8B, an example will be described where a block size candidate to divide the given frame tF is selected based on the CU greatest in number among the CUs included in a CTB of the reference frame rF.

The CTB depicted in FIG. 8A includes 3 CUs of 32×32 [pixels], which is depth 1 and 4 CUs of 16×16 [pixels], which is depth 2. The coding apparatus 100 selects any depth candidate to divide the given frame tF, based on depth 2, which is the smallest depth.

The CTB depicted in FIG. 8B includes 2 CUs of 32×32 [pixels], which is depth 1; 7 CUs of 16×16 [pixels], which is depth 2; and 4 CUs of 8×8 [pixels], which is depth 3. The coding apparatus 100 selects any depth candidate to divide the given frame tF, based on depth 2, which is greatest in number.

Three detailed examples of depth candidate selection will be described with reference to FIGS. 9 to 11. The depth candidate table 711 depicted in FIGS. 9 to 11 is a table storing depth candidates for each depth. In the depth candidate table 711 depicted in FIGS. 9 to 11, “depth” is omitted in each record to simplify the figure. The depth candidate table 711 will be described with reference to FIG. 9.

FIG. 9 is a diagram depicting a first example of depth candidates for performing motion vector detection for a given frame. The depth candidate table 711 depicted in FIG. 9 has records 901-1 to 901-4.

The depth candidate table 711 has 2 fields, reference frame depth and given frame depth candidate. The reference frame depth field stores depth results for the reference frame rF, the depth results being search keys. The given frame depth candidate field stores depth candidate values for the given frame tF, corresponding to the specified reference frame depth and described in FIGS. 8A and 8B.

For example, record 901-2 indicates that when the reference frame depth is depth 1, the given frame depth candidates are depths 0 to 2.

Records 901-2 and 901-3 store in the given frame depth candidate field, as approximate depths, depths that with respect to the reference frame depth, are the same size, 1 size smaller, and 1 size larger, respectively.

Record 901-1 stores depths 0 to 2 in the given frame depth candidate field since the reference frame depth is depth 0, which is the largest depth. Record 901-1 may store depth 0 in the reference frame depth field and depths 0 and 1 in the given frame depth candidate field.

FIG. 10 is a diagram depicting a second example of depth candidates for performing motion vector detection for a given frame. The depth candidate table 711 depicted in FIG. 10 has records 1001-1 to 1001-4. For example, record 1001-2 indicates that when the reference frame depth is depth 1, the given frame depth candidates are depths 0 to 2.

Records 1001-3 and 1001-4 store in the given frame depth candidate field, as approximate depths, depths that with respect to the reference frame depth, are the same size, 1 size larger, and 2 sizes larger, respectively.

Record 1001-2 stores depths 0 to 2 in the given frame depth candidate field since there is no depth that is 2 sizes larger than the reference frame depth. Record 1001-2 may store depths 0 and 1 in the given frame depth candidate field.

Thus, the depth candidate table 711 depicted in FIG. 10 selects depth candidates such that the depth becomes larger and therefore, when video that is to be coded has minimal change, such as the sky, drops in image quality can be further suppressed.

FIG. 11 is a diagram depicting a third example of depth candidates for performing motion vector detection for a given frame. The depth candidate table 711 depicted in FIG. 11 has records 1101-1 to 1101-4. For example, record 1101-2 indicates that when the reference frame depth is depth 1, the given frame depth candidates are depths 1 to 3.

Records 1101-1 and 1101-2 store in the given frame depth candidate field, as approximate depths, depths that with respect to the reference frame depth, are the same size, 1 size smaller, and 2 sizes smaller, respectively.

Record 1101-3 stores depths 1 to 3 in the given frame depth candidate field since there is no depth that is 2 sizes smaller than the reference frame depth. Record 1101-3 may store depths 2 and 3 in the given frame depth candidate field.

Thus, the depth candidate table 711 depicted in FIG. 11 selects depth candidates such that the depth becomes smaller and therefore, when video that is to be coded has many edges and changes, drops in image quality can be further suppressed.

The depth candidate tables 711 depicted in FIGS. 9 to 11 indicate contents stored when the CTB is 64×64 [pixels]. For example, if the CTB is 32×32 [pixels], the given frame depth candidate field of the depth candidate table 711 stores 2 depths or 1 depth.

Here, differences in the depth candidate tables 711 depicted in FIGS. 9 to 11 are described. First, the extent to which drops in image quality is suppressed when the depth candidate tables 711 depicted in FIGS. 9 to 11 are employed will be described. A case where drops in image quality can be further suppressed is when the depth determined by the second motion vector detection process and the depth determined by the first motion vector detection process have a high probability of matching. In a case where the coding apparatus 100 employs the depth candidate tables 711 depicted in FIGS. 9 and 10, experimental results are obtained that indicate that the probability of matching becomes higher than when the coding apparatus 100 uses the depth candidate table 711 depicted in FIG. 11.

Further, the depth candidate table 711 that the coding apparatus 100 is to use among the depth candidate tables 711 depicted in FIGS. 9 to 11 may be specified by the developer or the user of the coding apparatus 100.

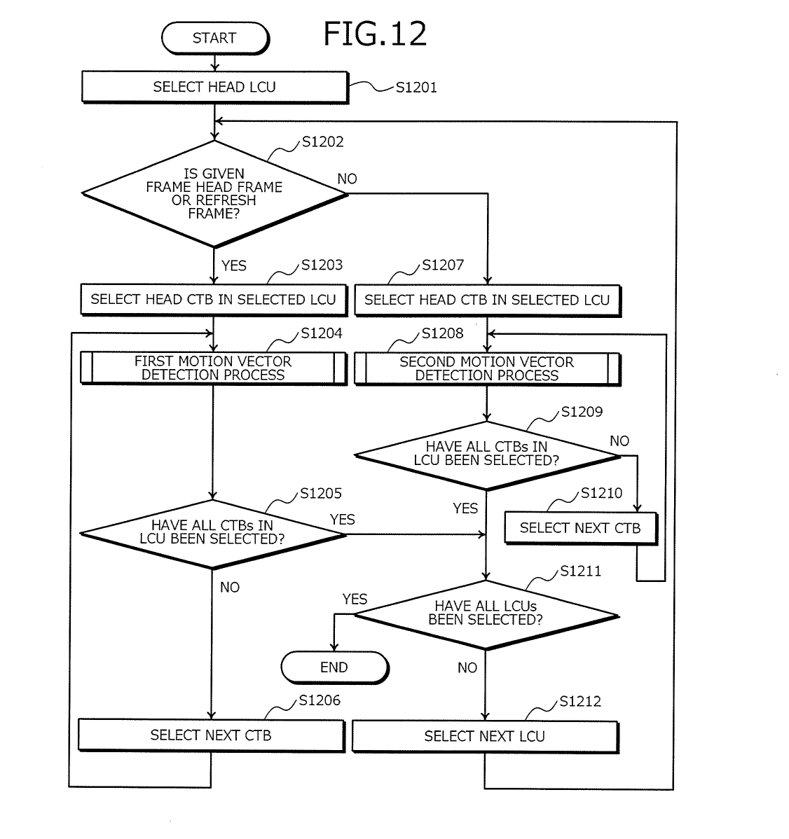

In a case where the user of the coding apparatus 100 specifies the depth candidate table 711 to be used, the coding apparatus 100 displays a setting screen on the display 209 and displays a dialog indicating that the depth candidate table 711 that is to be used is to be selected from among the depth candidate tables 711. The coding apparatus 100 receives identification information of the depth candidate table 711 specified by the user, corresponding to the contents of the video that is to be coded. For example, if the video to be coded is video of the sky, etc., the user of the coding apparatus 100 specifies the depth candidate table 711 depicted in FIG. 10 and when the video has many edges, the user specifies the depth candidate table 711 depicted in FIG. 11. Flowcharts executed by the coding apparatus 100 will be described with reference to FIGS. 12 to 15.

A flowchart of the motion vector detection process in a given frame tF will be described with reference to FIGS. 12 and 13. The coding apparatus 100 employs any one of the flowcharts depicted in FIG. 12 and FIG. 13 to detect a motion vector.

FIG. 12 is a flowchart depicting a first example of a procedure of the motion vector detection process in a given frame. The motion vector detection process in a given frame is a process of detecting motion vectors of PUs included in a given frame tF.

The coding apparatus 100 selects the head LOU in the given frame tF (step S1201). The coding apparatus 100 determines if the given frame tF is the head frame or a refresh frame (step S1202). Here, a refresh frame is a frame other than a given i-th frame.

If the given frame tF is the head frame or a refresh frame (step S1202: YES), the coding apparatus 100 selects the head CTB in the selected LCU (step S1203). The coding apparatus 100 executes the first motion vector detection process (step S1204). Details of the first motion vector detection process will be described with reference to FIG. 14. The coding apparatus 100 determines whether all CTBs in the LCU have been selected (step S1205). If a CTB that has yet to be selected is present (step S1205: NO), the coding apparatus 100 selects the next CTB (step S1206). The coding apparatus 100 transitions to the operation at step S1204.

If the given frame tF is not the head frame and is not a refresh frame (step S1202: NO), the coding apparatus 100 selects the head CTB in the selected LCU (step S1207). The coding apparatus 100 executes the second motion vector detection process (step S1208). Details of the second motion vector detection process will be described with reference to FIG. 15. The coding apparatus 100 determines whether all CTBs in the LCU have been selected (step S1209). If a CTB that has yet to be selected is present (step S1209: NO), the coding apparatus 100 selects the next CTB (step S1210). The coding apparatus 100 transitions to the operation at step S1208.

If all CTBs have been selected (step S1205: YES, step S1209: YES), the coding apparatus 100 determines whether all LCUs in the given frame tF have been selected (step S1211). If an LCU that has yet to be selected is present (step S1211: NO), the coding apparatus 100 selects the next LOU (step S1212). The coding apparatus 100 transitions to the operation at step S1202.

If all LCUs have been selected (step S1211: YES), the coding apparatus 100 ends the motion vector detection process in the given frame tF. The coding apparatus 100 can detect motion vectors of the PUs included in the given frame tF, by executing the motion vector detection process in the given frame.

FIG. 13 is a flowchart of a second example of the procedure of the motion vector detection process in a given frame. The motion vector detection process in a given frame is a process of detecting motion vectors of PUs included in a given frame tF. Further, operations at step S1301 and steps S1303 to S1312 depicted in FIG. 13 are the same operations as those at step S1201 and steps S1203 to S1212 and therefore, description thereof will be omitted.

After completion of the operation at step S1301 or step S1312, the coding apparatus 100 determines whether ABS(LCU flatness of given frame tF−LCU flatness of reference frame rF) is greater than a given threshold (step S1302). Here, ABS( ) is a function that returns the absolute value of an argument. Further, flatness is obtained by equation (1).

flatness=(ΣABS(pixel value in LCU−average pixel value in LCU))/total pixel count in LCU (1)

The pixel value in the LCU is, for example, a luminance signal Y. Further, the pixel value in the LOU may be color-difference signals Cb and Cr. The total pixel count in the LOU is 4096. Further, in place of equation (1), flatness may be the average pixel value in the LCU, distribution of the pixel values in the LCU, or standard deviation of the pixel values in the LCU.

If ABS(LCU flatness of given frame tF−LOU flatness of reference frame rF) is greater than a given threshold (step S1302: YES), the coding apparatus 100 executes the operation at step S1303. On the other hand, if ABS(LCU flatness of given frame tF−LCU flatness of reference frame rF) is less than or equal to the given threshold (step S1302: NO), the coding apparatus 100 transitions to the operation at step S1307.

The coding apparatus 100 can detect motion vectors for PUs included in the given frame tF by executing the motion vector detection process in the given frame. Further, by comparing the difference in flatness, the coding apparatus 100 performs the first motion vector detection process if the given frame tF changes greatly from the reference frame rF. Thus, if the reference frame rF and the given frame tF are not similar, the motion vector detection process is performed for all depths and therefore, by the flowchart depicted in FIG. 13, the coding apparatus 100 can suppress drops in image quality.

In FIGS. 14 and 15, a PU evaluation value and a CU evaluation value are calculated. The PU evaluation value and the CU evaluation value use a motion estimation (ME) cost as an evaluation value. ME cost is an estimate of the coding volume of a motion vector or the coding volume for specifying a reference image. Equation (2) is a calculation formula Cost, which is the ME cost.

Cost(ModeεΩ)=SAD+λ*R (2)

Where, Ω is a universal set of a candidate mode for coding a given PU. SAD (sum of absolute difference) represents the sum of absolute difference of pixel values at positions corresponding to blocks in the reference frame rF and a block subject to motion vector detection. λ is a Lagrange undetermined multiplier provided as a function of the quantization parameter. R is the total coding volume in a case of coding by the given mode Mode. The evaluation value is not limited to equation (2) and may use SAD, summation of square error (SSE).

FIG. 14 is a flowchart depicting an example of a procedure of the first motion vector detection process. The first motion vector detection process is a process of calculating evaluation values for all depth candidates and determining a motion vector. Further, in FIG. 14, the CTB is assumed to be 64×64 [pixels].

The coding apparatus 100 performs motion vector candidate detection for each PU of depth 0 and calculates evaluation values for the PUs (step S1401). More specifically, the coding apparatus 100 calculates an evaluation value for a PU of 64×64 [pixels]; a sum of evaluation values for the upper and lower PUs of 64×32 [pixels]; and a sum of evaluation values for the left and right PUs of 32×64 [pixels]. The evaluation values are values calculated using equation (2). Further, the sum of the evaluation values for the upper and lower PUs of 64×32 [pixels] is regarded “evaluation value for PU of 64×32 [pixels]”. Similarly, the sum of evaluation values for the left and right PUs of 32×64 [pixels] is regarded “evaluation value for PU of 32×64 [pixels]”.

The coding apparatus 100 determines the PU size for depth 0, based on the evaluation values for the PUs of depth 0 (step S1402). More specifically, the coding apparatus 100 determines the PU for which the evaluation value is smallest among the evaluation values for the PU of 64×64 [pixels], the PU of 64×32 [pixels], and the PU of 32×64 [pixels], to be the PU size for depth 0. Further, the smallest evaluation value is regarded to be the evaluation value for depth 0.

The coding apparatus 100 performs motion vector candidate detection for each PU of depth 1 (step S1403). More specifically, the coding apparatus 100 calculates an evaluation value for a PU of 32×32 [pixels]; a sum of evaluation values for the upper and lower PUs of 32×16 [pixels]; and a sum of evaluation values for the left and right PUs of 16×32 [pixels]. Further, when the CTB is 64×64 [pixels], depth 1 can include 4 CUs and therefore, the coding apparatus 100 repeats the operation at step S1403 four times. Further, the sum of the evaluation values for the upper and lower PUs of 32×16 [pixels] is regarded as “evaluation value for PU of 32×16 [pixels]”. Similarly, the sum of evaluation values for the left and right PUs of 16×32 [pixels] is regarded as “evaluation value for PU of 16×32 [pixels]”.

The coding apparatus 100 determines the PU size for depth 1, based on the evaluation values for the PUs of depth 1 (step S1404). More specifically, the coding apparatus 100 determines the PU for which the evaluation value is smallest among the evaluation values for the PU of 32×32 [pixels], the PU of 32×16 [pixels], and the PU of 16×32 [pixels], to be the PU size for depth 1. Further, the coding apparatus 100 regards the smallest evaluation value to be the evaluation value for depth 1. When the CTB is 64×64 [pixels], depth 1 can include 4 CUs and therefore, the coding apparatus 100 repeats the operation at step S1404 four times.

The coding apparatus 100 performs motion vector candidate detection for each PU of depth 2 and calculates an evaluation value for each PU (step S1405). More specifically, the coding apparatus 100 calculates an evaluation value for a PU of 16×16 [pixels]; a sum of evaluation values for the upper and lower PUs of 16×8 [pixels]; and a sum of evaluation values for the left and right PUs of 8×16 [pixels]. Further, when the CTB is 64×64 [pixels], depth 2 can include 16 CUs and therefore, the coding apparatus 100 performs the operation at step S1405 sixteen times. Further, the sum of the evaluation values for the upper and lower PUs of 16×8 [pixels] is regarded as “evaluation value for PU of 16×8 [pixels]”. Similarly, the sum of evaluation values for the left and right PUs of 8×16 [pixels] is regarded as “evaluation value for PU of 8×16 [pixels]”.

The coding apparatus 100 determines the PU size for depth 2, based on the evaluation values for the PUs of depth 2 (step S1406). More specifically, the coding apparatus 100 determines the PU for which the evaluation value is smallest among the evaluation values for the PU of 16×16 [pixels], the PU of 16×8 [pixels], and the PU of 8×16 [pixels], to be the PU size for depth 2. Further, the coding apparatus 100 regards the smallest evaluation value to be the evaluation value for depth 2. When the CTB is 64×64 [pixels], depth 2 can include 16 CUs and therefore, the coding apparatus 100 repeats the operation at step S1406 sixteen times.

The coding apparatus 100 performs motion vector candidate detection for each PU of depth 3 and calculates an evaluation value for each PU (step S1407). More specifically, the coding apparatus 100 calculates an evaluation value for a PU of 8×8 [pixels]; a sum of evaluation values for the upper and lower PUs of 8×4 [pixels]; and a sum of evaluation values for the left and right PUs of 4×8 [pixels]. Further, when the CTB is 64×64 [pixels], depth 3 can include 64 CUs and therefore, the coding apparatus 100 performs the operation at step S1407 sixty-four times. Further, the sum of the evaluation values for the upper and lower PUs of 8×4 [pixels] is regarded as “evaluation value for PU of 8×4 [pixels]”. Similarly, the sum of evaluation values for the left and right PUs of 4×8 [pixels] is regarded as “evaluation value for PU of 4×8 [pixels]”.

The coding apparatus 100 determines the PU size for depth 3, based on the evaluation values for the PUs of depth 3 (step S1408). More specifically, the coding apparatus 100 determines the PU for which the evaluation value is smallest among the evaluation values for the PU of 8×8 [pixels], the PU of 8×4 [pixels], and the PU of 4×8 [pixels], to be the PU size for depth 3. Further, the coding apparatus 100 regards the smallest evaluation value to be the evaluation value for depth 3. When CTB is 64×64 [pixels], depth 3 can include 64 CUs and therefore, the coding apparatus 100 repeats the operation at step S1408 sixty-four times.

The coding apparatus 100 detects a motion vector based on the evaluation values for the PU sizes determined for depths 0 to 3 (step S1409). More specifically, the coding apparatus 100 selects the depth for which the evaluation value is smallest among the evaluation values obtained by the operations at steps S1402, S1404, S1406, and S1408, for depths 0 to 3, respectively. The coding apparatus 100 detects, as the motion vector, the motion vector candidate of the PU size determined for the depth having the smallest evaluation value.

More specifically, the coding apparatus 100, in the selected CTB, compares the sum of evaluation values of the 4 CUs positioned at the upper left of depth 3 and the evaluation value of 1 CU of depth 2, the 1 CU being the same area as an area combining the 4 CUs of depth 3. If the evaluation value of the 1 CU of depth 2 is small, the coding apparatus 100 compares the magnitudes of the sum of evaluation values of the 4 CUs positioned at the upper left of depth 2 and the evaluation value of 1 CU of depth 1, the 1 CU being the same area as an area combining the 4 CUs of depth 2. For example, if the sum of the evaluation values of the 4 CUs positioned at the upper left of depth 2 is small, the coding apparatus 100 divides the upper left area in a selected CTB by the 4 CUs of depth 2. The coding apparatus 100 similarly processes the remaining areas. Thus, the coding apparatus 100 divides selected CTBs by CUs of plural depths.

After completion of the operation at step S1409, the coding apparatus 100 ends the first motion vector detection process. Consequent to executing the first motion vector detection process, the coding apparatus 100 can detect the motion vector for which the evaluation value is smallest.

The flowchart depicted in FIG. 14 depicts a case where the CTB is 64×64 [pixels]. For example, when the CTB is 32×32 [pixels], the coding apparatus 100 executes the operations at steps S1403 to S1409.

FIG. 15 is a flowchart depicting an example of a procedure the second motion vector detection process. The second motion vector detection process is a process of calculating an evaluation value of a depth candidate that is approximately the reference frame depth and determining a motion vector.

The coding apparatus 100 specifies a depth of a CTB at the same position as the reference frame rF (step S1501). A detailed procedure of specifying a depth of a CTB at the same position as a reference frame rF is described with reference to FIGS. 8A and 8B. The coding apparatus 100 refers to the depth candidate table 711 and selects any depth candidate that corresponds to the depth of the CTB at the same position as the reference frame rF (step S1502). The coding apparatus 100 selects the head depth candidate among selected any depth candidates (step S1503).

The coding apparatus 100 performs motion vector candidate detection for the PUs of the selected depth candidate and calculates an evaluation value for each PU (step S1504). The coding apparatus 100 determines the PU size of the selected depth, based on the evaluation values of the PUs of the selected depth candidate (step S1505). The contents of the operation at step S1504 and the contents of the operation at step S1505 vary depending on the selected depth.

More specifically, when the selected depth is depth 0, the coding apparatus 100 performs the same operation as that at step S1401, as the operation at step S1504; and performs the same operation as that at step S1402, as the operation at step S1505. When the selected depth is depth 1, the coding apparatus 100 performs the same operation as that at step S1403, as the operation at step S1504; and performs the same operation as that at step S1404, as the operation at step S1505.

Similarly, when the selected depth is depth 2, the coding apparatus 100 performs the same operation as that at step S1405, as the operation at step S1504; and performs the same operation as that at step S1406, as the operation at step S1505. Further, when the selected depth is depth 3, the coding apparatus 100 performs the same operation as that at step S1407, as the operation at step S1504; and performs the same operation as that at step S1408, as the operation at step S1505.

The coding apparatus 100 determines whether all depth candidates among the any depth candidates have been selected (step S1506). If a depth candidate that has yet to be selected among the any depth candidates is present (step S1506: NO), the coding apparatus 100 selects the next depth candidate among the any depth candidates (step S1507). After completing the operation at step S1507, the coding apparatus 100 transitions to the operation at step S1504.

If all of the any depth candidates have been selected (step S1506: YES), the coding apparatus 100 detects a motion vector, based on the evaluation value of the PU size determined for each of the any depth candidates (step S1508). After completing the operation at step S1508, the coding apparatus 100 ends the second motion vector detection process. By executing the second motion vector detection process, the coding apparatus 100 can detect from among the any depth candidates that are approximately the depth of the reference frame rF, a motion vector for which the evaluation value is smallest.

As described, when performing motion vector detection for a block of a given frame, the coding apparatus 100 uses a block size equivalent to the block size employed during motion vector detection for a block of the reference frame. As a result, the coding apparatus 100 can suppress drops in image quality of video after coding and can reduce the volume of calculation involved in the motion vector detection process.

More specifically, the coding apparatus 100 performs the motion vector detection process for 3 depths with respect to processing of performing the motion vector detection process for 4 depths and therefore, can reduce the volume of calculation involved in the motion vector detection process by 25%.

The coding apparatus 100 may calculate an evaluation value for a selected depth candidate among all depth candidates to detect a motion vector. As a result, since an evaluation value is calculated for a selected depth candidate, the coding apparatus 100 can suppress drops in image quality and reduce the volume of calculation involved in the detection of a motion vector.

The coding apparatus 100 may specify 1 depth or 2 or more depths as depths of the reference frame rF. For example, when depths of the reference frame rF are depths 0 to 2, the coding apparatus 100 may specify as the depth of the reference frame rF, depth 1, or depths 0 and 1. When 2 depths may potentially be specified as a depth of the reference frame rF, the depth candidate table 711 stores 2 records of the depth for the reference frame rF.

Further, in a case where plural depths are specified when a motion vector of the reference frame rF is detected, the coding apparatus 100 may specify the depth of the reference frame rF based on the respective depths. For example, the coding apparatus 100 may specify, as the depth of the reference frame rF, the depth that is smallest among the depths. When the reference frame rF has a depth making a small division, the given frame tF also has high possibility of being divided into a small division. Thus, the coding apparatus 100 specifies the smallest depth as the depth of the reference frame rF and thereby, can suppress drops in image quality.

Further, when plural depths are specified when a motion vector of the reference frame rF is detected, the coding apparatus 100 may select any depth candidate, based on a count of the CUs divided according to each of the depths. For example, the coding apparatus 100 may specify the depth for which the number of CU sizes is greatest among the depths. As a result, the coding apparatus 100 narrows the depth down to the depth by which the reference frame rF is divided and performs motion vector detection, enabling drops in image quality to be suppressed. Further, since the smaller the CU size is, the greater the CU size count is, the coding apparatus 100 may specify the depth of the reference frame rF, based on the CU size count, weighted by a weight related to the magnitude of the CU size.

The coding apparatus 100 performs the second motion vector detection process when the given frame tF is a given i-th frame in a series of frames and performs the first motion vector detection process when the given frame tF is a frame other than a given i-th frame. For example, the reference frame rF and the given frame tF are assumed to not be similar as a result of a change in scenery, etc. in a given frame among a series of frames. In this case, the coding apparatus 100 performs the first motion vector detection process when the given frame tF is not a given i-th frame and thus, can perform coding by a block size suitable for the contents of the image and can suppress drops in image quality.

Further, configuration may be such that the coding apparatus 100 performs the second motion vector detection process when the difference in flatness of the given frame tF and the reference frame rF is a given threshold or less and performs the first motion vector detection process when the difference is greater than the given threshold. For example, a change in scenery from reference frame rF is assumed in a given frame. In this case, the flatness of the given frame tF and the flatness of the reference frame rF change drastically and therefore, the coding apparatus 100 performs the first motion vector detection process. In this manner, the coding apparatus 100 performs the first motion vector detection process when the reference frame rF and the given frame tF no longer resemble each other and thereby, can suppress drops in image quality.

In the present embodiment, although the PUs (interframe prediction units) for which calculation is performed are decreased and the volume of calculation involved in the motion vector detection process is reduced, the block sizes that can be selected as a transform unit (TU), which is a unit of orthogonal transform, may be reduced. There are 4 types of TUs, 4×4 [pixels], 8×8 [pixels], 16×16 [pixels], and 32×32 [pixels]. Orthogonal transform is means to separate into low frequency components and high frequency components, pixel values of an image before conversion, to thereby facilitate image compression at a preprocessing stage of performing image compression.

The coding method described in the present embodiment may be implemented by executing a prepared program on a computer such as a personal computer and a workstation. The coding program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

The coding apparatus 100 described in the present embodiment can be realized by an application specific integrated circuit (ASIC) such as a standard cell or a structured ASIC, or a programmable logic device (PLD) such as a field-programmable gate array (FPGA). Specifically, for example, the determining unit 701 to the detecting unit 705, and the depth candidate table 711 of the coding apparatus 100 are defined in hardware description language (HDL), which is logically synthesized and applied to the ASIC, the PLD, etc., thereby enabling manufacture of the coding apparatus 100.

According to one aspect of the embodiments, an effect is achieved in that drops in image quality are suppressed and the volume of calculation involved in motion vector detection can be decreased.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A coding apparatus comprising:
a specifying circuitry configured to specify concerning a reference frame that is a reference for a given frame that is to be coded and is in a series of frames, a block size when a motion vector of a block divided from the reference frame is detected, the block size being specified from among a plurality of block size candidates of the block; and
a selecting circuitry configured to select from among the plurality of block size candidates, a block size candidate to divide the given frame, when a motion vector of a block divided from the given frame is detected, the block size candidate being selected based on the block size specified by the specifying circuitry.

2. The coding apparatus according to claim 1, further comprising:
a calculating circuitry configured to calculate corresponding to the block size candidate selected by the selecting circuitry, an evaluation value representing a difference of a pixel value of a reference block that is within a search range on the reference frame and a pixel value of each block divided from the given frame according to the block size candidate; and
a detecting circuitry configured to detect based on the evaluation value calculated by the calculating circuitry for each block divided according to the block size candidate, a motion vector of a block divided from the given frame.

3. The coding apparatus according to claim 1, wherein
the selecting circuitry, when a plurality of block sizes for the block is specified by the specifying circuitry when the motion vector of the block divided from the reference frame is detected, selects the block size candidate to divide the given frame, from among the plurality of block size candidates and based on a block size that is relatively small among respective block sizes of the plurality of block sizes.

4. The coding apparatus according to claim 1, wherein
the selecting unit circuitry, when a plurality of block sizes for the block is specified by the specifying circuitry when the motion vector of the block divided from the reference frame is detected, selects the block size candidate to divide the given frame, from among the plurality of block size candidates and based on a count of blocks divided according to each block size among the plurality of block sizes.

5. The coding apparatus according to claim 1, further comprising
a determining circuitry configured to determine whether the given frame is a given i-th frame in the series of frames, wherein
the specifying unit circuit specifies the block size when the given frame is determined to be the given i-th frame by the determining circuitry.

6. The coding apparatus according to claim 1, further comprising
a determining circuitry configured to determine whether a value representing a difference of a pixel value of the given frame and a pixel value of the reference frame is less than a given threshold, wherein
the specifying circuit specifies the block size when the value is determined to be less than the given value by the determining circuit.

7. A computer system comprising:
a specifying circuitry configured to specify concerning a reference frame that is a reference for a given frame that is to be coded and is in a series of frames, a block size when a motion vector of a block divided from the reference frame is detected, the block size being specified from among a plurality of block size candidates of the block; and
a selecting circuitry configured to select from among the plurality of block candidates, any block size to divide the given frame, when a motion vector of a block divided from the given frame is detected, the block size candidate being selected based on the block size specified by the specifying circuitry.

8. A coding method comprising:
specifying concerning a reference frame that is a reference for a given frame that is to be coded and is in a series of frames, a block size when a motion vector of a block divided from the reference frame is detected, the block size being specified from among a plurality of block size candidates of the block; and
selecting from among the plurality of block candidates, any block size to divide the given frame, when a motion vector of a block divided from the given frame is detected, the block size candidate being selected based on the specified block size, wherein
the coding method is executed by a computer.
